(19) United States
(12) Patent Application Publication
(10) Pub. No.: US 2014/0040960 A1
(43) Pub. Date: Feb. 6, 2014

(54) ROAMING MEDIA SYSTEM AND METHOD

(71) Applicant: ISAAC S. DANIEL, Miramar, FL (US)

(72) Inventor: ISAAC S. DANIEL, Miramar, FL (US)

(21) Appl. No.: 13/212,795

(22) Filed: Aug. 18, 2011

Related U.S. Application Data
(60) Provisional application No. 61/374,893, filed on Aug. 18, 2010.

(51) Int. Cl. H04N 7/20; H04N 7/173

(52) U.S. Cl. 725/68; 725/110

(57) ABSTRACT

A portable media system comprising at least one media receiver having at least one video or audio output, wherein the at least one media receiver is operative to communicate with at least one media service provider while roaming; and at least one unique identifier embedded on the at least one media receiver.

### PRIORITY CLAIM

The present application is a continuation-in-part of and claims priority to U.S. provisional patent application Ser. No. 61/374,893, filed on Aug. 18, 2010, titled “Portable Media System and Method,” by Isaac Sayo Daniel, which is herein incorporated by reference in its entirety as if fully stated herein.

### FIELD

The present disclosure relates generally to electronic systems, apparatuses, and methods, and more particularly, to systems, methods, and various other disclosures related to television devices, such as signal converters, cable boxes, and the like.

### BACKGROUND

Many media service providers, such as cable and television companies, provide their customers with devices that are operative to receive media service. One such example is a type of set top box commonly referred to as a “cable box.” Cable boxes are devices that receive a signal, usually a television signal, from television service provider. Cable boxes have traditionally served the purpose of converting the digital cable signal into an analog signal for televisions to display.

Since most modern televisions include digital signal converters, or are capable of displaying video directly from a digital signal, modern cable boxes perform many other functions such as providing video on demand, high definition channels, pay per view content, descrambling, and digital video recording.

Traditional cable boxes have been passive, meaning that they only receive information such as by tuning to a certain television channel. Modern cable boxes provide for two-way communication between the cable box and the service provider, which allows for more interactive services like video on demand to be provided. Modern cable boxes are also addressable, meaning that the service provider can independently identify one box from another.

Up until now, the use of cable boxes has been limited to single, fixed locations, such as a customer's home. In fact, many service contracts prevent customers from moving their cable boxes to a different address. Thus, if a customer would like to watch the same programming they receive at home while traveling, they are unable to do so.

### SUMMARY

The various embodiments of systems and methods described herein result from the realization that media services can be provided on a portable basis through a portable media device, such as a portable cable box, which can be plugged into any cable outlet and used in a roaming mode.

Accordingly, the various embodiments and disclosures described herein solve the limitations of the prior art in a new and novel manner.

### BRIEF DESCRIPTION OF THE DRAWINGS

FIG. 1 shows a portable media system in accordance with one embodiment;

FIG. 2 shows a system for broadcasting media in accordance with one embodiment; and

FIG. 3 shows a block diagram depicting a method for broadcasting media in accordance with one embodiment.

### DETAILED DESCRIPTION OF PREFERRED EMBODIMENTS

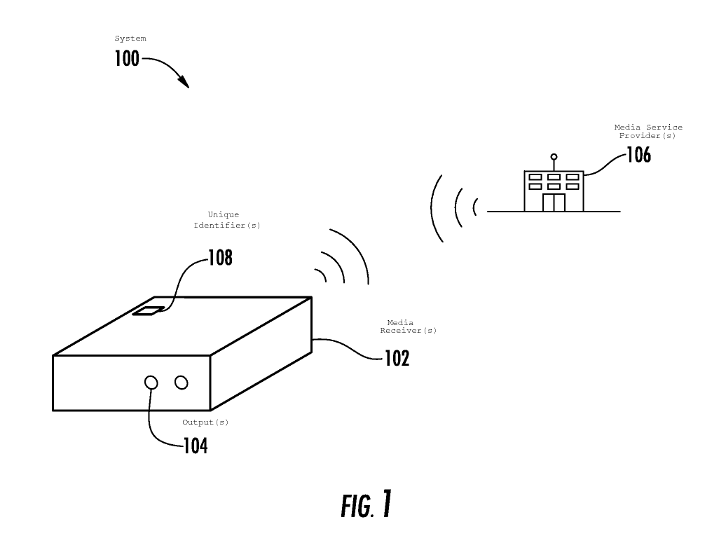

FIG. 1 shows an embodiment of a portable media system 100, comprising at least one media receiver 102 having at least one video or audio output 104, wherein at least one media receiver 102 is operative to communicate with at least one media service provider 106 while roaming, and at least one unique identifier 108 embedded in at least one media receiver 102.

In some embodiments, at least one media receiver 102 may be any type of media receiver, such as, but not limited to, a step top box, a television box, a television receiver, a cable television box, a satellite television box, an internet modem and/or receiver, and the like.

In some embodiments, at least one media service provider 106 may be any kind of media service provider, such as, but not limited to, a television service provider, a cable television service provider, a satellite television service provider, an internet service provider, and the like.

In other embodiments, at least one media receiver 102 may be operative to connect or communicate with at least one media service provider 106 while roaming using at least one communications means, such as, but not limited to, a TV tuner card, a computer network card, a cable modem, a DSL modem, a satellite modem, coaxial cable, telephone lines, satellite communications, fiber optic communications, internet communications, wireless communications, such as GSM, and the like.

In some embodiments, at least one unique identifier 108 may be any kind of unique identifier, such as, but not limited to, a hardware based unique identifier, such as a MAC address, cable box identifier, and the like, or may be a software or firmware based unique identifier, such as a programmed unique identifier, and the like. In some embodiments, at least one unique identifier 108 may be used to determine whether at least one media receiver 102 belongs to a certain media network.

In some embodiments, at least one video or audio output 104 may be any kind of video or audio output, such as, but not limited to, an RCA output, a composite cable output, a component cable out, an HDMI output, a coaxial cable output, a USB output, and the like.

In one embodiment, system 100 further comprises at least one media provider central station, wherein the media provider central station is operative to communicate with at least one media receiver 102. In some embodiments, the at least one media provider central station may be at least one media service provider 106, part of or similar to at least one media service provider 106.

In a further embodiment, the at least one media provider central station may be operative to determine whether at least one media receiver 102 is part of the media provider central station's network or whether at least one media receiver 102 is outside of the media provider central station's network. In some embodiments, determining whether at least one media receiver 102 is outside or inside of the media provider's network may comprise using at least one unique identifier 108, such as by comparing at least one unique identifier 108 to a database of unique identifiers to determine if at least one unique identifier 108 is within or outside of the media provider's network.

In some embodiments, the at least one media provider central station may be operative to broadcast media to at least one media receiver 102. The media may be any type of media, such as, but not limited to, television programming, movies, internet, music, and the like. In a further embodiment, the at least one media provider central station may be operative to broadcast media to at least one media receiver 102 if it is determined that at least one media receiver 102 outside of the media provider central station's network. In another embodiment, the at least one media provider central station is operative to broadcast media at a roaming rate, which may be higher than a subscription rate, if it is determined that at least one media receiver 102 is outside of the media provider central station's network.

The terms “roaming” or “roaming rate,” as used herein, may refer to when a media service provider has to use another provider's signals (and therefore towers, equipment, and lines) to keep a certain media receiver in service. Both providers typically have a mutually beneficial agreement to use the other's signal to extend their customer's coverage. The terms of the companies' contract may not be detailed in a customer's own service contract, but the customer's provider will usually establish a set of rules and rates for roaming.

In some embodiments, the at least one media provider central station is operative to broadcast media to at least one media receiver 102, wherein the media is similar or identical to media to which at least one media receiver 102 is subscribed to in its original network.

In some embodiments, the at least one media receiver 102 comprises a type of media receiver selected from the group consisting essentially of a cable box, an internet protocol television (IPTV) receiver, such as an IPTV set top box, personal computing device, mobile computing device, and the like, a satellite television box, and the like.

In another embodiment, the at least one media provider central station comprises a type of media provider central station selected from the group consisting essentially of a cable television provider, an internet protocol television provider, a satellite television provider, a video on demand provider, a streaming video provider, and the like.

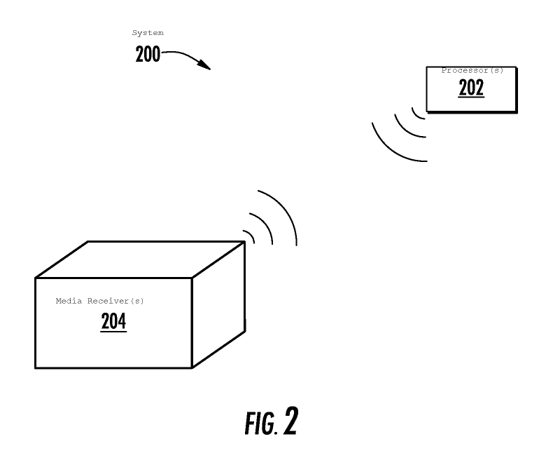

Referring now to FIG. 2, a system for broadcasting media 200 is shown in accordance with one embodiment, wherein system 200 comprises at least one processor 202, and computer executable instructions (not shown) readable by at least one processor 202 and operative to determine whether a media receiver 204 connected to at least one processor 202 is part of a subscriber network (not shown), and broadcast media to media receiver 204 at a roaming rate if media receiver 204 is not part of the subscriber network.

The terms “connected,” “electronically connected,” “electronic connection,” or “connection,” “communication,” when used in the context of electronic devices and systems, and the like, as used throughout the present disclosure, are intended to describe any type of electronic connection or electronic communication, such as, but not limited to, a physically connected or wired electronic connection and/or a wireless electronic connection, such as a direct connection, a connection through a network, or through wireless communications protocol such as Bluetooth® and Zigbee®.

At least one processor 202 may be any type of processor, such as, but not limited to, a central processing unit (CPU), a microprocessor, a video processor, a front end processor, a coprocessor, a single-core processor, a multi-core processor, and the like. The computer executable instructions may be any type of computer executable instructions, which may be in the form of a computer program, the program being composed in any suitable programming language or source code, such as C++, C, C*, JAVA, JavaScript, HTML, XML, and other programming languages.

In some embodiments, at least one processor 202 may be part of or located in a media service provider central station, or media service provider system.

In a further embodiment, determining whether media receiver 204 connected to at least one processor 202 is part of a particular network includes determining whether media receiver 204 is part of a particular subscriber network. In some embodiments, the network and/or subscriber network may be any type of network, such as a television service network, an internet service network, and the like. In some embodiments, system 200 may comprise additional elements, such as those described above in system 100 with reference to FIG. 1.

In some embodiments, media receiver 202 comprises a type of media receiver selected from the group consisting essentially of a cable box, an internet protocol television (IPTV) receiver, such as an IPTV set top box, personal computing device, mobile computing device, and the like, a satellite television box, and the like.

In another embodiment, the subscriber network comprises a subscriber network selected from the group consisting essentially of a cable television network, an internet protocol television network, a satellite television network, a video on demand network, a streaming video network, and the like.

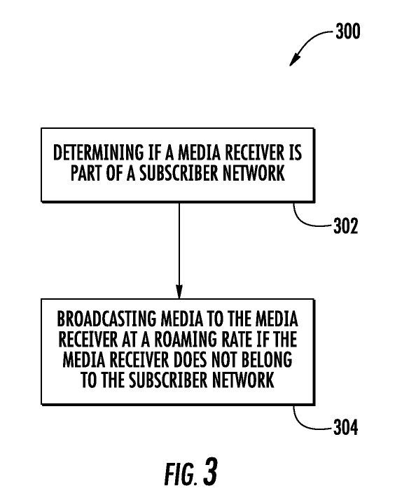

Referring now to FIG. 3, a block diagram depicting a method of broadcasting media 300 is shown in accordance with one embodiment, wherein method 300 comprises using at least one processor to perform any or all of the following: determining whether a media receiver is within a subscriber network (block 302), and broadcasting media to the media receiver at a roaming rate if the media receiver does not belong to the subscriber network (block 304).

In some embodiments, the at least one processor may be any type of processor, such as those described above with reference to FIGS. 1 and 2. In other embodiments, the media receiver may be any type of media receiver, such as those described above with reference to FIGS. 1 and 2. In yet other embodiments, the subscriber network may be any type of network, such as those described above with reference to FIGS. 1 and 2.

In one embodiment of method 300, broadcasting media to the media receiver comprises broadcasting media to the media receiver at a roaming rate if the media receiver is outside a particular subscriber network. In another embodiment, broadcasting media to the media receiver comprises broadcasting subscribed media to the media receiver. In yet another embodiment, broadcasting media to the media receiver comprises broadcasting subscribed media to the media receiver even if the media receiver is outside of or does not belong to a particular subscriber network. The subscribed media may be the media to which the media receiver is subscribed to in the particular subscriber network to which the media receiver belongs.

For example, in one embodiment, a media service provider may agree to broadcast media to a particular media receiver that is outside of its subscriber network, or in other words, roaming, wherein the media, such as television content, may be similar or identical to the media to which the media receiver is subscribed to in its original network, such as similar or identical television channels, or in the context of internet, similar data transfer rate. Accordingly, in some embodiments, the at least one processor may reside in or be a part of the media service provider's systems.

In some embodiments, broadcasting media to the media receiver comprises broadcasting media to the media receiver, wherein the media may be similar or identical to the media to which the media receiver is subscribed to in its original network.

In some embodiments, the media receiver comprises a type of media receiver selected from the group consisting essentially of a cable box, an internet protocol television (IPTV) receiver, such as an IPTV set top box, personal computing device, mobile computing device, and the like, a satellite television box, and the like.

In another embodiment, the subscriber network comprises a subscriber network selected from the group consisting essentially of a cable television network, an internet protocol television network, a satellite television network, a video on demand network, a streaming video network, and the like.

In a further embodiment, the processor may be part of a media service provider, which may operate a subscriber network.

In some embodiments, method 300 may incorporate or be used by the various components and elements of the various embodiments of systems 100 and 200 described above with reference to FIGS. 1 and 2.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed is:

1. A portable home television set top box system comprising:
a. at least one home television set top box having at least one video or audio output, wherein the at least one home television set top box is operative to:
(a) be associated with a first home television service provider's subscriber network;
(b) connect to a second home television service provider, wherein the second home television service provider comprises a subscriber network, and wherein the at least one home television set top box is not associated with the second home television service provider's subscriber network; and
(c) receive television content from the from the second home television service provider at a roaming rate; and
b. at least one unique identifier embedded on the at least one home television set top box, wherein the at least one unique identifier may be used to determine whether the at least one home television set top box is subscribed to a television service provider's network.

2. The portable home television set top box system of claim 1, further comprising:
a. at least one home television service provider, wherein the at least one home television service provider is operative to communicate with the at least one home television set top box.

3. The portable home television set top box system of claim 2, wherein the at least one home television service provider is operative to determine whether the at least one home television set top box is part of the at least one home television service provider's subscriber network.

4. The portable home television set top box system of claim 3, wherein the at least one home television service provider is operative to broadcast television content to the at least one home television set top box.

5. The portable home television set top box system of claim 4, wherein the at least one home television service provider is operative to broadcast television content to the at least one home television set top box if it is determined that the at least one home television set top box is outside of the at least one home television service provider's subscriber network.

6. The portable home television set top box system of claim 5, wherein the at least one home television service provider media provider is operative to broadcast television content at a roaming rate to the at least one home television set top box if it is determined that the at least one home television set top box is outside of the at least one home television service provider's subscriber network.

7. The portable home television set top box system of claim 3, wherein the at least one home television service provider is operative to broadcast television content to the at least one home television set top box, wherein the television content is similar or identical to television content to which the at least one home television set top box is subscribed to in its original network.

8. The portable home television set top box system of claim 1, wherein the at least one home television set top box comprises a type of home television set top box selected from the group consisting essentially of:
a. a cable television set top box;
b. an internet protocol television set top box;
d. and
e. a satellite television set top box.

9. The portable home television set top box system of claim 2, wherein the at least one home television service provider comprises a type of home television service provider selected from the group consisting essentially of:
a. a home cable television service provider;
b. an home internet protocol television service provider;
c. a home satellite television service provider;
d. a home video on demand service provider; and
e. a home streaming video service provider.

10. A system for broadcasting television content comprising:
a. at least one processor; and
b. computer executable instructions readable by the at least one processor and operative to:
(a) determine whether a home television set top box connected to the at least one processor is part of a home television service provider subscriber network; and
(b) broadcast television content to the home television set top box at a roaming rate if the home television set top box is not part of the home television service provider subscriber network.

11. The system of claim 10, wherein the home television set top box comprises a type of home television set top box selected from the group consisting essentially of:
a. a cable television set top box;
b. an internet protocol television set top box;
d. and
e. a satellite television set top box.

12. The system of claim 10, wherein the home television service provider subscriber network comprises a type of home television service provider subscriber network selected from the group consisting essentially of:
a. a home cable television service provider subscriber network;
b. an home internet protocol television service provider subscriber network;
c. a home satellite television service provider subscriber network;
d. a home video on demand service provider subscriber network; and
e. a home streaming video service provider subscriber network.

13. A method of broadcasting television content, comprising using at least one processor to perform any or all of the following:
a. determining if a home television set top box is part of a home television service provider subscriber network; and
b. broadcasting television content to the home television set top box at a roaming rate if the home television set top box does not belong to the home television service provider subscriber network.

14. The method of claim 13, wherein broadcasting television content to the home television set top box comprises broadcasting subscribed television content to the home television set top box.

15. The method of claim 13, wherein the television content is similar or identical to the television content to which the home television set top box is subscribed to in its original network.

16. The method of claim 13, wherein the home television set top box comprises a type of home television set top box selected from the group consisting essentially of:
a. a cable television set top box;
b. an internet protocol television set top box;
d. and
e. a satellite television set top box.

17. The method of claim 13, wherein the home television service provider subscriber network comprises a type of home television service provider subscriber network selected from the group consisting essentially of:
a. a home cable television service provider subscriber network;
b. an home internet protocol television service provider subscriber network;
c. a home satellite television service provider subscriber network;
d. a home video on demand service provider subscriber network; and
e. a home streaming video service provider subscriber network.

18. The method of claim 13, wherein the processor is part of a home television service provider.
